(19) United States
(12) Patent Application Publication
(10) Pub. No.: US 2013/0250748 A1
(43) Pub. Date: Sep. 26, 2013

(54) APPARATUS AND METHOD FOR PROVIDING MULTI-RAB SERVICE IN COMMUNICATION SYSTEM

(71) Applicant: SAMSUNG ELECTRONICS CO., LTD, Gyeonggi-do (KR)

(72) Inventors: In-Soo Lee, Gyeonggi-do (KR); Hyo-Joon Kim, Gyeonggi-do (KR); Seung-Yeob Lee, Gyeonggi-do (KR); Jae-Kwang Han, Gyeonggi-do (KR); Young-IL Chang, Gyeonggi-do (KR)

(73) Assignee: Samsung Electronics Co., Ltd, Gyeonggi-do (KR)

(21) Appl. No.: 13/850,967

(22) Filed: Mar. 26, 2013

(30) Foreign Application Priority Data
Mar. 26, 2012 (KR) 10-2012-0030430

(51) Int. Cl. H04W 76/06

(52) U.S. Cl. CPC H04W 76/064
USPC 370/216

(57) ABSTRACT

An apparatus implements a method for maintaining a voice call in a communication system providing a multi-Radio Access Bearer (RAB). In the method for maintaining a voice call in an electronic device, a data call and a voice call with a wireless network are connected. When an error of the data call is detected, the connection of the data call with the wireless network is released.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Mar. 26, 2012 and assigned Serial No. 10-2012-0030430, the entire disclosure of which is hereby incorporated by reference.

### TECHNICAL FIELD

The present disclosure relates to a communication system. More particularly, the present disclosure relates to an apparatus and a method for providing a multi-Radio Access Bearer (multi-RAB) service in a communication system.

### BACKGROUND

As a communication technology develops, various wireless communication services using a wireless network are provided. For example, a wireless communication system provides a voice communication service between users via a communication electronic device. For another example, a wireless communication system provides a data service such as a wireless Internet service in order to meet a user's demand for a multimedia service.

The wireless communication system provides a multi-RAB service for connecting, a voice call and a data call together between nodes in order to swiftly provide a voice communication service and a data service.

In the case where an error of a data call occurs during a multi-RAB state, the wireless communication system releases both a data call and a voice call between nodes due to the error of the data call. That is, a user of an electronic device cannot use even a voice communication service due to the error of the data call.

### SUMMARY

To address the above-discussed deficiencies, embodiments of the present disclosure provide an apparatus and a method for providing a multi-RAB service in a communication system.

Certain embodiments of the present disclosure include an apparatus and a method for maintaining a voice call connection when an error of a data call occurs in a communication system providing a multi-RAB service.

Certain embodiments of the present disclosure include an apparatus and a method for releasing a data call while maintaining a voice call when an error of the data call occurs in a communication system providing a multi-RAB service.

Certain embodiments of the present disclosure include an apparatus and a method for releasing a data call while maintaining a voice call when an error of the data call occurs based on the number of retransmissions in a communication system providing a multi-RAB service.

Certain embodiments of the present disclosure include an apparatus and a method for releasing a data call while maintaining a voice call when an error of the data call occurs depending on a wireless network state in a communication system providing a multi-RAB service.

Certain embodiments of the present disclosure include a method for maintaining a voice call in an electronic device providing a multi-Radio Access Bearer (RAB). The method includes connecting a data call and a voice call with a wireless network, and when an error of the data call is detected, releasing the connection of the data call with the wireless network.

Certain embodiments of the present disclosure include a method for maintaining a voice call in a base station providing a multi-Radio Access Bearer (RAB). The method includes connecting a data call and a voice call with an electronic device, and when an error of the data call is detected, releasing the connection of the data call with the electronic device.

Certain embodiments of the present disclosure include an apparatus for maintaining a voice call in an electronic device providing a multi-Radio Access Bearer (RAB). The apparatus includes a receiver for receiving a signal, a transmitter for transmitting a signal, and a controller for connecting a data call and a voice call with a wireless network using the receiver and the transmitter. When an error of the data call is detected, the controller releases the connection of the data call with the wireless network.

Certain embodiments of the present disclosure include an apparatus for maintaining a voice call in a base station providing a multi-Radio Access Bearer (RAB). The apparatus includes a transmitter for transmitting a signal, a receiver for receiving a signal, and a controller for connecting a data call and a voice call with an electronic device using the transmitter and the receiver. When an error of the data call is detected, the controller releases the connection of the data call with the electronic device.

Other aspects, advantages and salient features of the invention will become apparent to those skilled in the art from the following detailed description, which, taken in conjunction with the annexed drawings, discloses embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or: the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings:

FIG. 1 illustrates a procedure for maintaining a voice call in a communication system according to embodiments of the present disclosure;

FIG. 2 illustrates a procedure for maintaining a voice call with a base station in an electronic device according to embodiments of the present disclosure;

FIG. 3 illustrates a procedure for maintaining a voice call with an electronic device in a base station according to embodiments of the present disclosure;

FIG. 4 illustrates a procedure for maintaining a voice call with a base station based on the number of data retransmissions of an electronic device according, to embodiments of the present disclosure;

FIG. 5 illustrates a procedure for maintaining a voice call with an electronic device based on the number of data retransmissions of a base station according to embodiments of the present disclosure;

FIG. 6 illustrates a procedure for maintaining a voice call with a base station based on the number of data retransmissions of an electronic device according to embodiments of the present disclosure;

FIG. 7 illustrates a procedure for maintaining a voice call with an electronic device based on the number of data retransmissions of a base station according to embodiments of the present disclosure;

FIG. 8 illustrates a procedure for maintaining a voice call with a base station based on a wireless network state of an electronic device according to embodiments of the present disclosure;

FIG. 9 illustrates a procedure for maintaining a voice call in a communication system according to embodiments of the present disclosure;

FIG. 10 illustrates a procedure for maintaining a voice call with an electronic device based on the number of data retransmissions of a base station according to embodiments of the present disclosure;

FIG. 11 illustrates a procedure for maintaining a voice call with a base station based on the number of data retransmissions of an electronic device according to embodiments of the present disclosure;

FIG. 12 illustrates a procedure for maintaining a voice call with an electronic device based on the number of data retransmissions of a base station according to embodiments of the present disclosure;

FIG. 13 illustrates a procedure for maintaining a voice call with a base station based on the number of data retransmissions of an electronic device according to embodiments of the present disclosure;

FIG. 14 illustrates a base station according to embodiments of the present disclosure; and

FIG. 15 illustrates an electronic device according to embodiments of the present disclosure.

Throughout the drawings, like reference numerals will be understood to refer to like parts, components and structures.

### DETAILED DESCRIPTION

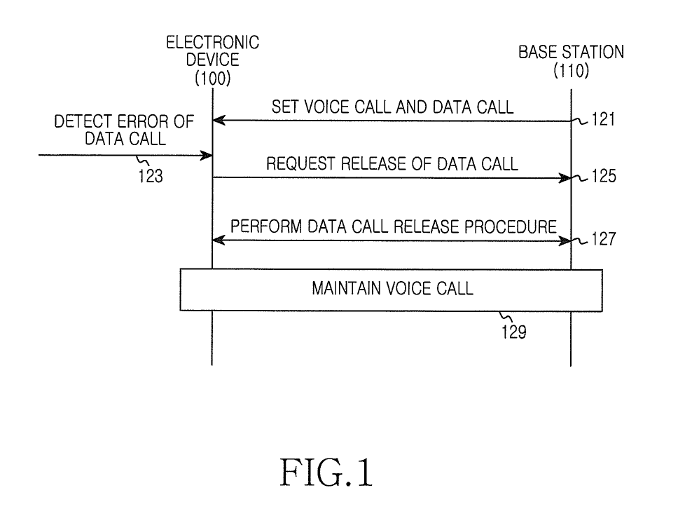

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication device or wireless communication system. The following description with reference to the accompanying drawings is provided to assist in a comprehensive understanding of embodiments of the present disclosure as defined by the claims and their equivalents. The present disclosure includes various specific details to assist in that understanding but these embodiments of the present disclosure are to be regarded as mere examples. Accordingly, those of ordinary skill in the art will recognize that various changes and modifications of the embodiments described herein can be made without departing from the scope and spirit of the present disclosure. Also, descriptions of well-known functions and constructions are omitted for clarity and conciseness.

The terms and words used in the following description and claims are not limited to the bibliographical meanings, but, are merely a clear and consistent understanding of the present disclosure. Accordingly, it should be apparent to those skilled in the art that the following description of embodiments of the present disclosure is provided for illustration purposes only and not for the purpose of limiting the appended claims and their equivalents.

Embodiments of the present disclosure provide a technology for maintaining a voice call when an error of a data call occurs in a communication system providing a multi-RAB service.

In the following description, a base station can represent a wireless network providing a wireless communication service to an electronic device.

In the following description, examples of the electronic device include a mobile communication terminal, a Personal Digital Assistant (PDA), a laptop computer, a smart phone, a netbook, a television, a Mobile Internet Device (MID), an Ultra Mobile Personal Computer (UMPC), a tablet Personal Computer (PC), a navigation, and an MP3.

FIG. 1 illustrates a procedure for maintaining a voice call in a communication system according to embodiments of the present disclosure.

As illustrated in FIG. 1, an electronic device 100 and a base station 110 set a voice call and a data call (step 121). That is, the electronic device 100 and the base station 110 set a multi-RAB state.

In the case where an error of a data call is detected during the multi-RAB state (step 123), the electronic device 100 requests the base station 110 to release the data call in order to prevent both the connections of the data call and the voice call from being released due to the error of the data call with the base station 110 (step 125). For example, in step 125, the electronic device 100 transmits Signaling Connection Release Indication (SCRI) to the base station 110.

The base station 110 performs a data call release procedure with the electronic device 100 as a result of receiving the data call release request of the electronic device 100 (step 127). For example, the base station 110 performs the data call release procedure with the electronic device 100 via a Radio Bearer Release. Specifically, the base station 110 sets a domain to a Packet Switched (PS) domain and transmits the same to the electronic device 100. The electronic device 100 releases the data call with the base station 110 according to the PS domain provided from the base station 110. At this point, the electronic device 100 maintains a Packet Data Protocol (PDP) context with the base station 110.

Accordingly, the electronic device 100 and the base station 110 can maintain the voice call and provide a voice service even when an error of the data call occurs (step 129).

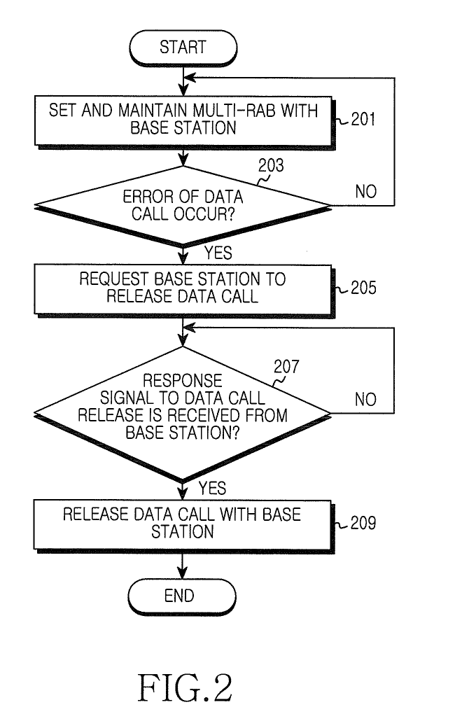

When an error of a data call between nodes is detected, a wireless communication system providing a multi-RAB service releases connections of the data call and a voice call between nodes via cell update. Accordingly, to prevent a connection release of the voice call, the wireless communication system can release a data call connection between the electronic device 100 and the base station 110 before cell update occurs, thereby maintaining, the voice call. At this point, the electronic device 100 operates as illustrated in FIG. 2.

FIG. 2 illustrates a procedure for maintaining a voice call with a base station 110 in an electronic device 100 according to embodiments of the present disclosure.

Referring to FIG. 2, the electronic device sets a multi-RAB with the base station in block 201. That is, the electronic device 100 connects a voice call and a data call with the base station 110.

After that, the electronic device proceeds to block 203 to determine whether an error of the data call is detected. For example, the electronic device 100 determines whether a data transmission error (Radio Link Control (RLC)-unrecoverable error) or a radio link error is detected.

When the error of the data call is not detected, the electronic device proceeds to block 201 to maintain the multi-RAB state with the base station.

In contrast, when the error of the data call is detected, the electronic device proceeds to block 205 to request the base station to release the data call. For example, the electronic device 100 transmits a SCRI to the base station 110.

After that, the electronic device proceeds to block 207 to determine whether a response signal to the data call release request has been received from the base station.

When the response signal to the data call release request has been received from the base station, the electronic device proceeds to block 209 to release the data call connection with the base station. For example, in case of receiving a domain set to a PS domain from the base station 110, the electronic device 100 releases the data call connection with the base station. At this point, the electronic device 100 maintains PDP context with the base station.

After that, the electronic device 100 ends the present algorithm.

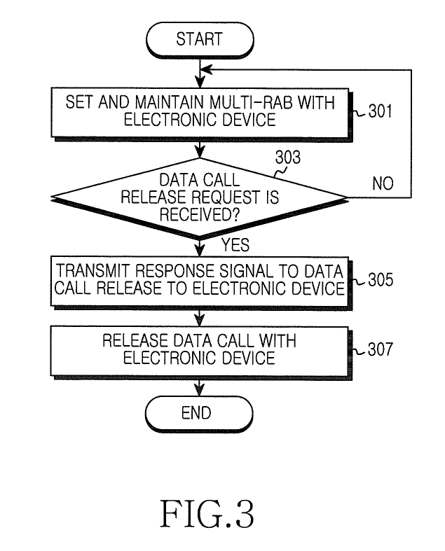

FIG. 3 illustrates a procedure for maintaining a voice call with an electronic device in a base station according to embodiments of the present disclosure.

Referring to FIG. 3, the base station sets a multi-RAB with the electronic device in block 301. That is, the base station 110 connects a voice call and a data call with the electronic device 100.

After that, the base station 110 proceeds to block 303 to determine whether the electronic device 100 requests a release of the data call. For example, the base station 110 determines whether a SCRI has been received from the electronic device 100.

When the electronic device 100 does not request the release of the data call, the base station 110 proceeds to block 301 to maintain the multi-RAB state with the electronic device.

In contrast, when the electronic device 100 requests the release of the data call, the base station 110 proceeds to block 305 to transmit a response signal to the data call release request to the electronic device. For example, the base station 110 sets a domain to a PS domain according to a radio bearer release and transmits the same to the electronic device 100.

After that, the base station proceeds to block 307 to release the data call connection with the electronic device. At this point, the base station 110 maintains the voice call connection with the electronic device and provides a voice service to the electronic device.

After that, the base station 110 ends the present algorithm.

As described above, when detecting an error of a data call before cell update by the error of the data call occurs, the electronic device 110 releases the data call connection with the base station as illustrated in FIG. 2. Accordingly, the electronic device 100 can maintain the voice call connection with the base station to receive the voice service from the base station.

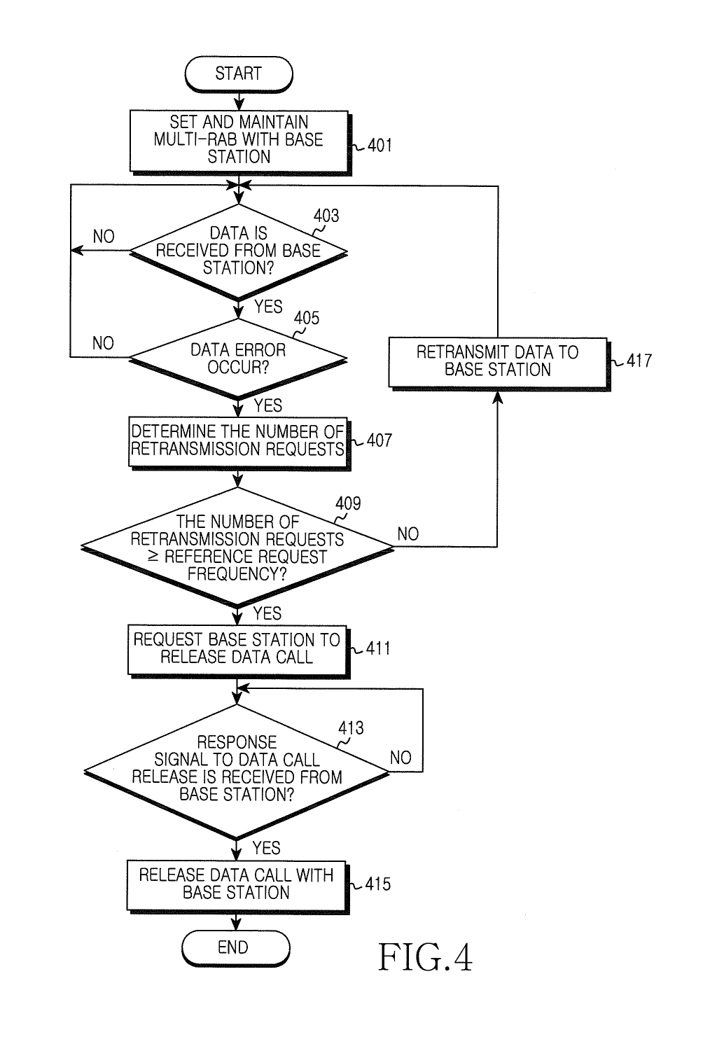

The electronic device 100 can determine whether an error of a data call occurs with consideration of a data transmission error as illustrated in FIG. 4.

FIG. 4 illustrates a procedure for maintaining a voice call with a base station based on the number of data retransmissions by an electronic device according to embodiments of the present disclosure.

Referring to FIG. 4, the electronic device sets a multi-RAB with the base station in block 401. That is, the electronic device 100 connects a voice call and a data call with the base station 110.

After that, the electronic device 100 proceeds to block 403 to determine whether data has been received from the base station. For example, the electronic device 100 determines whether data has been received from the base station 110 via the data call connected with the base station.

When data has been received from the base station, the electronic device 100 proceeds to block 405 to determine whether an error of the data received from the base station occurs.

When the error of the data received from the base station does not occur, the electronic device proceeds to block 403 to determine whether the next data has been received from the base station. At this point, the electronic device 100 transmits an acknowledgment message ACK for error-free data to the base station 110.

In contrast, when the error of the data received from the base station occurs, the electronic device proceeds to block 407 to determine the number of retransmission requests for the error-occurred data.

After that, the electronic device proceeds to block 409 to determine whether the number of retransmission requests is equal to or greater than a reference request frequency in order to determine whether retransmission of the error-occurred data is requested. The reference request frequency is set to a value equal to or less than a maximum request frequency by which the electronic device 100 can request the base station to retransmit data. That is, in the case where the electronic device 100 has requested retransmission of data as many as the maximum request frequency, but failed to receive the data, the wireless communication system performs a cell update, so that connections of the data call and the voice call between the base station and the electronic device are released. Accordingly, the reference request frequency is set to a value equal to or less than the maximum request frequency. At this point, the electronic device 100 receives the reference request frequency from the base station 110.

When the number of retransmission requests is less than the reference request frequency, the electronic device 100 recognizes that a retransmission request of the error-affected data is possible. Accordingly, the electronic device 100 proceeds to block 417 to request the base station to retransmit the error-occurred data. For example, the electronic device 100 transmits a NACK message for the error-affected data to the base station 110.

In contrast, when the number of retransmission requests is equal to or greater than the reference request frequency, the electronic device 100 determines that an error of data has occurred. Accordingly, the electronic device 100 proceeds to block 411 to request the base station 110 to release the data call. For example, the electronic device 100 transmits a SCRI to the base station 110.

After that, the electronic device 100 proceeds to block 413 to determine whether a response signal to the data call release request has been received from the base station.

When the response signal to the data call release request has been received from the base station, the electronic device 100 proceeds to block 415 to release the data call connection with the base station. For example, when receiving a domain set to a PS domain from the base station, the electronic device 100 releases the data call connection with the base station. At this point, the electronic device maintains the voice call connection with the base station 110 and receives a voice service from the base station.

After that, the electronic device 100 ends the present algorithm.

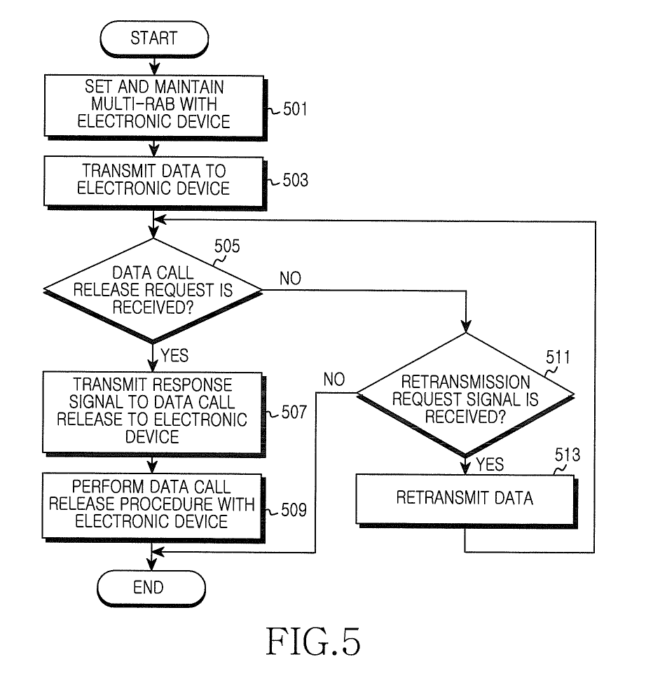

FIG. 5 illustrates a procedure for maintaining a voice call with an electronic device based on the number of data retransmissions by a base station according, to embodiments of the present disclosure.

Referring to FIG. 5, the base station sets a multi-RAB with the electronic device in block 501. That is, the base station 110 connects a voice call and a data call with the electronic device.

After that, the base station proceeds to block 503 to transmit data to the electronic device. For example, the base station 110 transmits data to the electronic device 100 via the data call connected with the electronic device.

After transmitting data to the electronic device, the base station 110 proceeds to block 505 to determine whether the electronic device 100 requested a release of the data call. For example, the base station 110 determines whether a SCRI has been received from the electronic device 110.

When the electronic device 100 does not request the release of the data call, the base station 110 proceeds to block 511 to determine whether a retransmission request signal has been received from the electronic device. For example, the base station 110 determines whether a NACK for data transmitted to the electronic device has been received.

When receiving an ACK for data transmitted to and received by the electronic device, the base station 110 recognizes that data transmission to the electronic device has been completed. Accordingly, the base station 110 ends the present algorithm. At this point, the base station 110 proceeds to block 503 to transmit the next data to the electronic device.

In contrast, when receiving a NACK for the data transmitted to and received by the electronic device, the base station 110 proceeds to block 513 to retransmit, to the electronic device, the data for which the NACK was received.

After that, the base station 110 proceeds to block 505 to determine whether the electronic device requests a release of the data call.

When the electronic device 100 requests the release of the data call, the base station 110 proceeds to block 507 to transmit a response signal to the data call release request by the electronic device to the electronic device. For example, the base station sets a domain to a PS domain according to a radio bearer release and transmits the same to the electronic device.

After that, the base station 110 proceeds to block 509 to release the data call connection with the electronic device. At this point, the base station 110 maintains the voice call connection with the electronic device and provides a voice service to the electronic device.

After that, the base station 110 ends the present algorithm.

In certain embodiments, the electronic device 100 determines whether an error of the data call occurs based on the number of retransmission requests for data that have been provided from the base station.

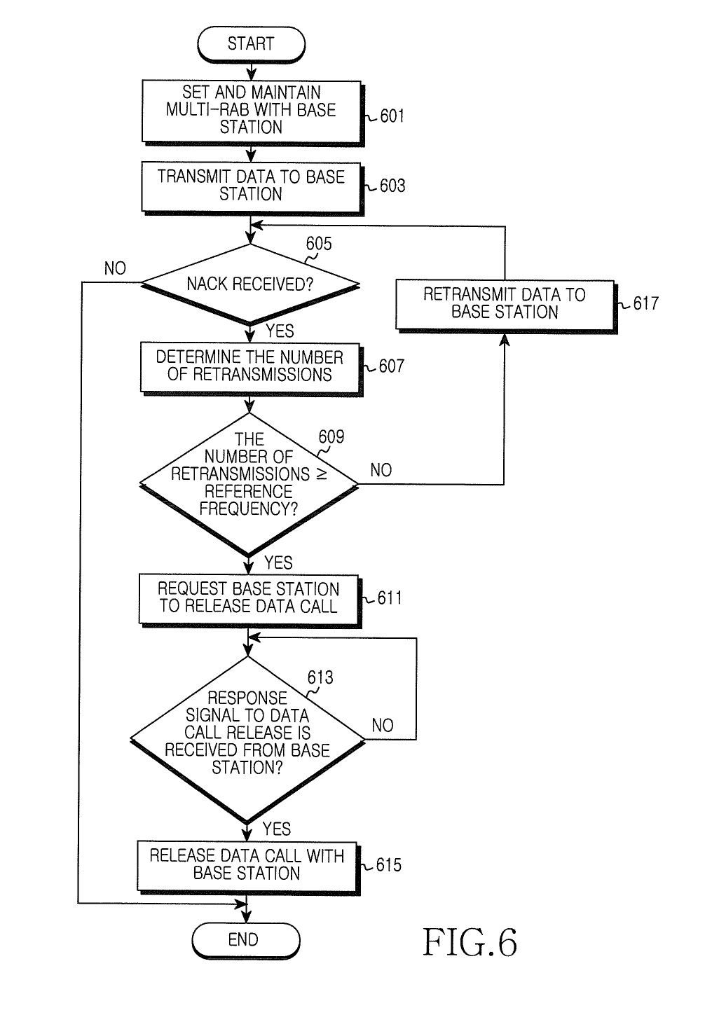

In certain embodiments, the electronic device 100 determines whether an error of the data call occurs based on the number of retransmissions of the data as illustrated in FIG. 6.

FIG. 6 illustrates a procedure for maintaining a voice call with a base station based on the number of data retransmissions by an electronic device according to embodiments of the present disclosure.

Referring to FIG. 6, the electronic device sets a multi-RAB with the base station in block 601. That is, the electronic device 100 connects a voice call and a data call with the base station 110.

After that, the electronic device 100 proceeds to block 603 to transmit data to the base station. For example, the electronic device 100 transmits data to the base station 110 via the data call connected with the electronic device.

After transmitting the data to the base station, the electronic device 100 proceeds to block 605 to determine whether a NACK associated with the data transmitted in block 603 has been received from the base station 110.

When receiving an ACK for the data transmitted in block 603 from the base station, the electronic device 100 recognizes that the data transmission is successful. Accordingly, the electronic device 100 proceeds to block 603 to transmit the next data to the base station.

In contrast, when receiving a NACK associated with the data transmitted in block 603 from the base station, the electronic device 100 proceeds to block 607 to determine the number of retransmissions of the data for the NACK.

After that, the electronic device 100 proceeds to block 609 to determine whether the number of retransmissions is equal to or greater than a reference frequency in order to determine whether a retransmission of the data associated with the NACK is possible. The reference frequency is set to a value equal to or less than a maximum transmission frequency by which the electronic device can retransmit data. That is, in the case where the electronic device 100 has retransmitted data as many as the maximum transmission frequency but failed to successfully transmit the data, the wireless communication system performs cell update, so that connections of the data call and the voice call between the base station and the electronic device are released. Accordingly, the reference frequency is set to a value equal to or less than the maximum transmission frequency. The electronic device 100 can receive the reference frequency from the base station.

When the number of retransmissions is less than the reference frequency, the electronic device 100 determines that retransmission of the data associated with the NACK is possible. Accordingly, the electronic device 100 proceeds to block 617 to retransmit the data associated with the NACK to the base station.

In contrast, when the number of retransmissions is equal to or greater than the reference frequency, the electronic device 100 determines that an error of the data call occurred. Accordingly, the electronic device 100 proceeds to block 611 to request the base station to release the data call. For example, the electronic device 100 transmits a SCRI to the base station 110.

After that, the electronic device 100 proceeds to block 613 to determine whether a response signal to the data call release request has been received from the base station.

When receiving the response signal associated with the data call release request from the base station, the electronic device 100 proceeds to block 615 to release the data call connection with the base station. For example, when receiving a domain set to a PS domain from the base station, the electronic device 100 releases the data call connection with the base station. At this point, the electronic device maintains the voice call connection with the base station 110 and continues to receive a voice service from the base station.

After that, the electronic device 100 ends the present algorithm.

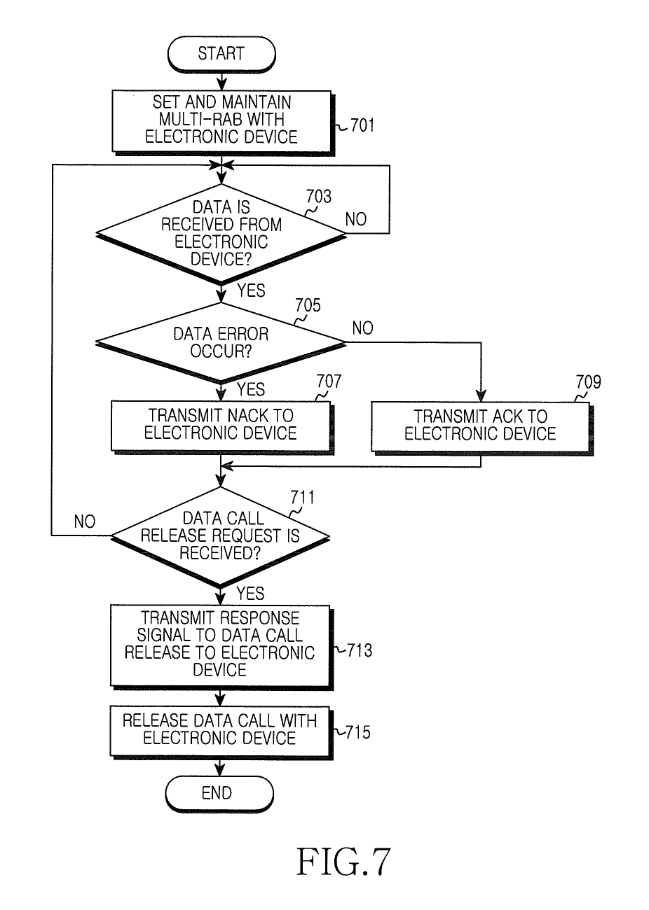

FIG. 7 illustrates a procedure for maintaining a voice call with an electronic device based on the number of data retransmissions by a base station according to embodiments of the present disclosure.

Referring to FIG. 7, the base station sets a multi-RAB with the electronic device in block 701. That is, the base station 110 connects a voice call and a data call with the electronic device 100.

After that, the base station 110 proceeds to block 703 to determine whether data has been received from the electronic device. For example, the base station 110 determines whether data is received from the electronic device 100 via the data call connected with the electronic device.

When receiving data from the electronic device, the base station 110 proceeds to block 705 to determine whether an error of the data received from the electronic device occurs.

When the error of the data received from the electronic device does not occur, the base station 100 determines that the data reception from the electronic device is successful. Accordingly, the base station 110 proceeds to block 709 to transmit an ACK associated with the error-free data to the electronic device.

After that, the base station 110 proceeds to block 703 to determine whether the next data has been received from the electronic device.

In contrast, when the error of the data received from the electronic device occurs, the base station 110 proceeds to block 707 to transmit a NACK associated with the error-occurred data to the electronic device.

After that, the base station 110 proceeds to block 711 to determine whether the electronic device requests release of the data call. For example, the base station 110 determines whether a SCRI has been received from the electronic device 100.

When the electronic device 100 does not request the release of the data call, the base station 110 proceeds to block 703 to determine whether the next data has been received from the electronic device.

In contrast, when the electronic device 100 requests the release of the data call, the base station 110 proceeds to block 713 to transmit a response signal associated with the data call release request to the electronic device. For example, the base station 110 sets a domain to a PS domain according to a radio bearer release and transmits the same to the electronic device 100.

After that, the base station 110 proceeds to block 715 to release the data call connection with the electronic device. At this point, the base station maintains the voice call connection with the electronic device and continues to provide a voice service to the electronic device.

After that, the base station 110 ends the present algorithm.

In certain embodiments, the electronic device 100 determines whether an error of the data call occurs based on a data transmission error.

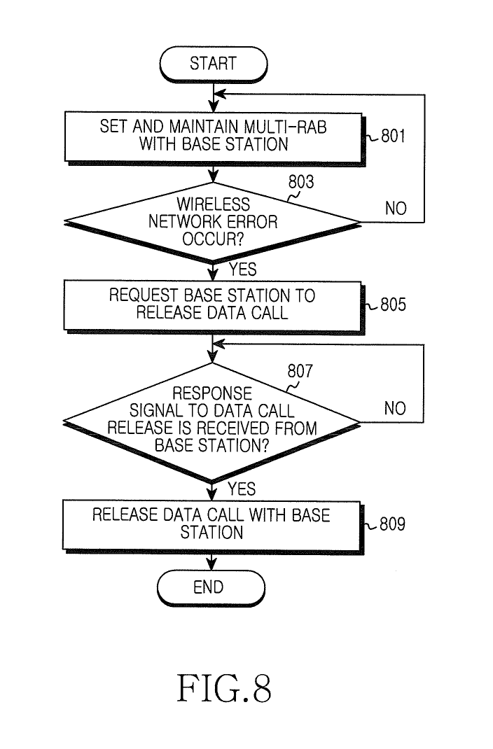

In certain embodiments, the electronic device 100 determines whether the error of the data call occurs based on a wireless network error as illustrated in FIG. 8.

FIG. 8 illustrates a procedure for maintaining a voice call with a base station based on a wireless network state of an electronic device according to embodiments of the present disclosure.

Referring to FIG. 8, the electronic device 100 sets a multi-RAB with the base station in block 801. That is, the electronic device 100 connects a voice call and a data call with the base station 110.

After that, the electronic device 100 proceeds to block 803 to determine whether an error of a wireless network with the base station has occurred. For example, the electronic device 100 determines whether the error of the wireless network with the base station occurs based on wireless channel estimate information with the base station. For another example, the electronic device 100 compares intensity of a signal provided from the base station 110 with a reference intensity to determine whether the error of the wireless network with the base station has occurred.

When the error of the wireless network does not occur, the electronic device 100 determines that an error of the data call has not occurred. Accordingly, the electronic device 100 proceeds to block 801 to maintain the multi-RAB with the base station.

In contrast, when the error of the wireless network occurs, the electronic device 100 determines that the error of the data call has occurred. Accordingly, the electronic device 100 proceeds to block 805 to request the base station 110 to release the data call. For example, the electronic device 100 transmits a SCRI to the base station 110.

After that, the electronic device 100 proceeds to block 807 to determine whether a response signal associated with the data call release request has been received from the base station.

When the response signal associated with the data call release request has been received from the base station, the electronic device 100 proceeds to block 809 to release the data call connection with the base station. For example, when receiving a domain set to a PS domain from the base station, the electronic device 100 releases the data call connection with the base station. At this point, the electronic device maintains the voice call connection with the base station and continues to receive a voice service from the base station.

After that, the electronic device 100 ends the present algorithm.

In certain embodiments, when an error of a data call occurs in the wireless communication system providing the multi-RAB service, the electronic device 100 requests the base station to release the connection of the data call.

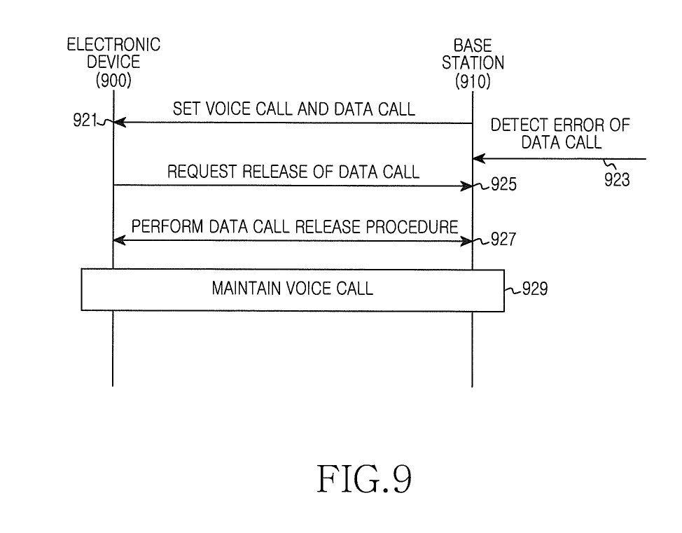

In certain embodiments, when an error of a data call occurs in the wireless communication system, the base station 110 requests the electronic device to release the connection of the data call as illustrated in FIG. 9.

FIG. 9 illustrates a procedure for maintaining a voice call in a communication system according to embodiments of the present disclosure.

As illustrated in FIG. 9, an electronic device 900 and a base station 910 set a voice call and a data call (step 921). That is, the electronic device 900 and the base station 910 set the multi-RAB state.

When detecting an error of the data call of the multi-RAB state (step 923), the base station 910 requests the electronic device 900 to release the data call in order to prevent both connections of the data call and the voice call from being released due to the error of the data call with the electronic device 900 (step 925).

After that, the base station 910 performs a data call release procedure with the electronic device 900. For example, the base station 910 performs the data call release procedure with the electronic device 900 via a radio bearer release (step 927). Specifically, the base station 910 sets a domain to a PS domain and transmits the same to the electronic device 900. The electronic device 900 releases the data call according to the PS domain provided from the base station 910. At this point, the electronic device 900 maintains Packet Data Protocol (PDP) information with the base station 910.

Accordingly, the electronic device 900 and the base station 910 maintain a voice call and continue to provide a voice service (step 929).

In certain embodiments, when detecting the error of the data call (step 923), the base station 910 requests the electronic device 900 to release the data call (step 925), and then performs the data call release procedure with the electronic device 900 (step 927).

In certain embodiments, when detecting the error of the data call (step 923), the base station 910 performs the data call release procedure with the electronic device 900 (step 927).

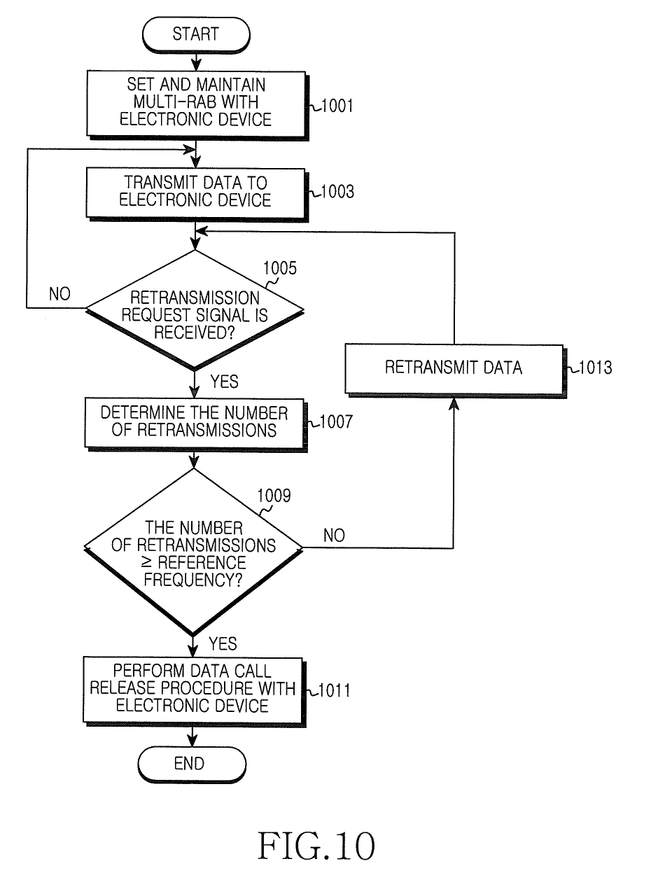

As described above, when detecting the error of the data call, the base station 910 of the wireless communication system requests the electronic device 900 to release the data call before cell update occurs in order to prevent the connections of the data call and the voice call from being released by the cell update. For example, the base station determines whether the error of the data call occurs based on a data transmission error as illustrated in FIG. 10.

FIG. 10 illustrates a procedure for maintaining a voice call with an electronic device based on the number of data retransmissions in a base station 910 according to embodiments of the present disclosure.

Referring to FIG. 10, the base station 910 sets a multi-RAB with the electronic device in block 1001. That is, the base station 910 connects a voice call and a data call with the electronic device 900.

After that, the base station 910 proceeds to block 1003 to transmit data to the electronic device 900. For example, the base station 910 transmits data to the electronic device 900 via the data call connected with the electronic device.

After transmitting the data to the electronic device, the base station 910 proceeds to block 1005 to determine whether a retransmission request signal has been received from the electronic device 900. For example, the base station 910 determines whether a NACK associated with the data transmitted to the electronic device has been received.

When receiving an ACK associated with the data transmitted to the electronic device, the base station 910 determines that data transmission to the electronic device has been completed. Accordingly, the base station 910 proceeds to block 1003 to transmit data to the next electronic device 900.

In contrast, when receiving a NACK associated with the data transmitted to the electronic device, the base station 910 proceeds to block 1007 to determine the number of retransmissions of the data associated with NACK.

After that, the base station 910 proceeds to block 1009 to determine the number of retransmissions is equal to or greater than a reference frequency in order to determine whether retransmission of the data associated with the NACK is possible. The reference frequency is set to a value equal to or less than a maximum transmission frequency by which the base station can retransmit data. That is, when the base station 910 has retransmitted data as many as the maximum retransmission frequency, but failed to transmit the data, the wireless communication system performs cell update, so that connections of the data call and the voice call between the base station and the electronic device are released. Accordingly, the reference frequency is set to a value equal to or less than the maximum transmission frequency.

When the number of retransmissions is less than the reference frequency, the base station 910 determines that retransmission of the data associated with the NACK is possible. Accordingly, the base station 910 proceeds to block 1013 to retransmit the data associated with the NACK to the electronic device 900.

In contrast, when the number of retransmissions is equal to or greater than the reference frequency, the base station 910 determines that an error of the data call has occurred. Accordingly, the base station 910 proceeds to block 1011 to perform a data call release procedure with the electronic device 900. For example, the base station 910 sets a domain to a PS domain according to a radio bearer release and transmits the same to the electronic device 900 to release the data call connection with the electronic device. At this point, the base station 910 maintains the voice call connection with the electronic device and continues to provide a voice service to the electronic device.

After that, the base station 910 ends the present algorithm.

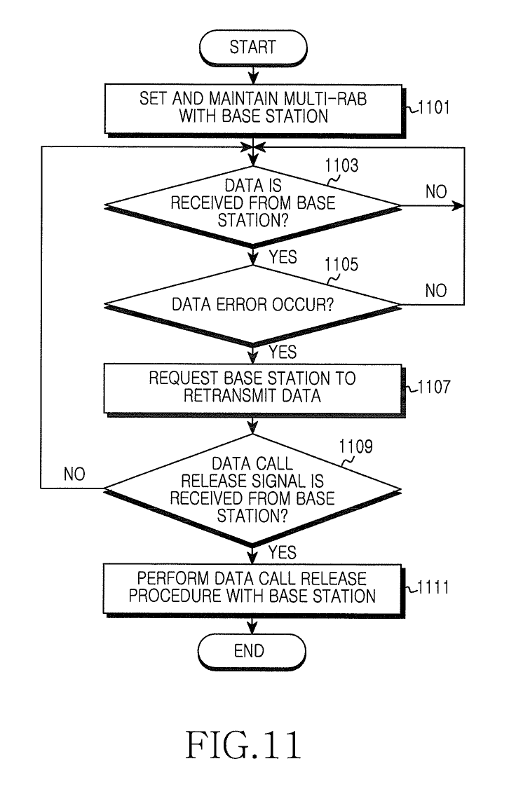

FIG. 11 illustrates a procedure for maintaining a voice call with a base station based on the number of data retransmissions by an electronic device 900 according to embodiments of the present disclosure.

Referring to FIG. 11, the electronic device 900 sets a multi-RAB with the base station in block 1101. That is, the electronic device 900 connects a voice call and a data call with the base station 910.

After that, the electronic device 900 proceeds to block 1103 to determine whether data has been received from the base station. For example, the electronic device 900 determines whether data has been received from the base station 910 via the data call connected with the base station.

When receiving the data from the base station, the electronic device 900 proceeds to block 1105 to determine whether an error of the data received from the base station has occurred.

When the error of the data received from the base station does not occur, the electronic device 900 proceeds to block 1103 to determine whether the next data has been received from the base station 910. At this point, the electronic device 900 transmits an ACK associated with the error-free data to the base station 910.

In contrast, when the error of the data received from the base station occurs, the electronic device 900 proceeds to block 1107 to request the base station 910 to retransmit the error-occurred data. For example, the electronic device 900 transmits a NACK f associated with or the error-occurred data to the base station 910.

After that, the electronic device 900 proceeds to block 1109 to determine whether a release signal for the data call has been received from the base station 910. For example, the electronic device 900 determines whether a signal set to a PS domain has been received from the base station 910.

When receiving a data call release signal from the base station, the electronic device 900 proceeds to block 1111 to release the data call connection with the base station. At this point, the electronic device 900 maintains the voice call connection with the base station 910 and continues to receive a voice service from the base station.

After that, the electronic device 900 ends the present algorithm.

In certain embodiments, the base station 910 determines whether an error of the data call occurs based on the number of retransmissions of data to the electronic device.

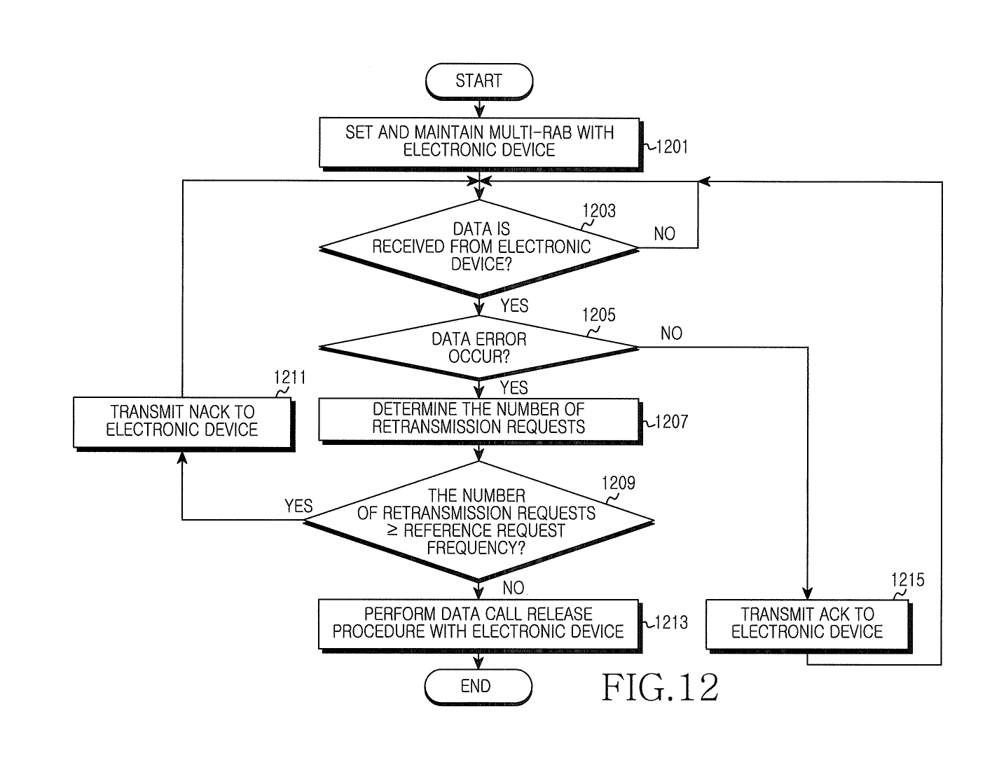

In certain embodiments, the base station 910 determines whether the error of the data call occurs based on the number of retransmission requests sent to the electronic device 900 as illustrated in FIG. 12.

FIG. 12 illustrates a procedure for maintaining a voice call with an electronic device based on the number of data retransmissions by a base station according to embodiments of the present disclosure.

Referring to FIG. 12, the base station 910 sets a multi-RAB with the electronic device in block 1201. That is, the base station 910 connects a voice call and a data call with the electronic device 900.

After that, the base station 910 proceeds to block 1203 to determine whether data has been received from the electronic device 900.

When receiving the data from the electronic device, the base station 910 proceeds to block 1205 to determine whether an error of the data received from the electronic device has occurred.

When the error of the data received from the electronic device does not occur, the base station 910 proceeds to block 1215 to transmit an ACK associated with the error-free data to the electronic device.

After that, the base station 910 proceeds to block 1203 to determine whether the next data has been received from the electronic device 900.

In contrast, when the error of the data received from the electronic device occurs, the base station 910 proceeds to block 1207 to determine the number of retransmission requests.

After that, the base station 910 proceeds to block 1209 to determine whether the number of retransmission requests is equal to or greater than the reference request frequency in order to determine whether the base station 910 can request the electronic device 900 to retransmit data. The reference request frequency is set to a value equal to or less than a maximum request frequency by which the base station 910 can request the electronic device 900 to retransmit data. That is, when the base station 910 has requested retransmission of data as many as the maximum request frequency, but failed to receive the data, the wireless communication system performs cell update, so that connections of a data call and a voice call between the base station and the electronic device are released. Accordingly, the reference request frequency is set to a value equal to or less than the maximum request frequency.

When the number of retransmission requests is less than the reference request frequency, the base station 910 determines that a retransmission request of the error-occurred data is possible. Accordingly, the base station 910 proceeds to block 1211 to request the electronic device 900 to retransmit the error-affected data. For example, the base station 910 transmits a NACK associated with the error-occurred data to the electronic device 900.

After that, the base station 910 proceeds to block 1203 to determine whether retransmission data has been received from the electronic device 900.

In contrast, when the number of retransmission requests is equal to or greater than the reference request frequency, the base station 910 determines that the error of the data call has occurred. Accordingly, the base station 910 proceeds to block 1213 to perform a data call release procedure with the electronic device. For example, the base station 910 sets a domain to a PS domain according to a radio bearer release and transmits the same to the electronic device 900 to release the data call connection with the electronic device 900. At this point, the base station maintains a voice call connection with the electronic device and continues to provide a voice service to the electronic device 900.

After that, the base station 910 ends the present algorithm.

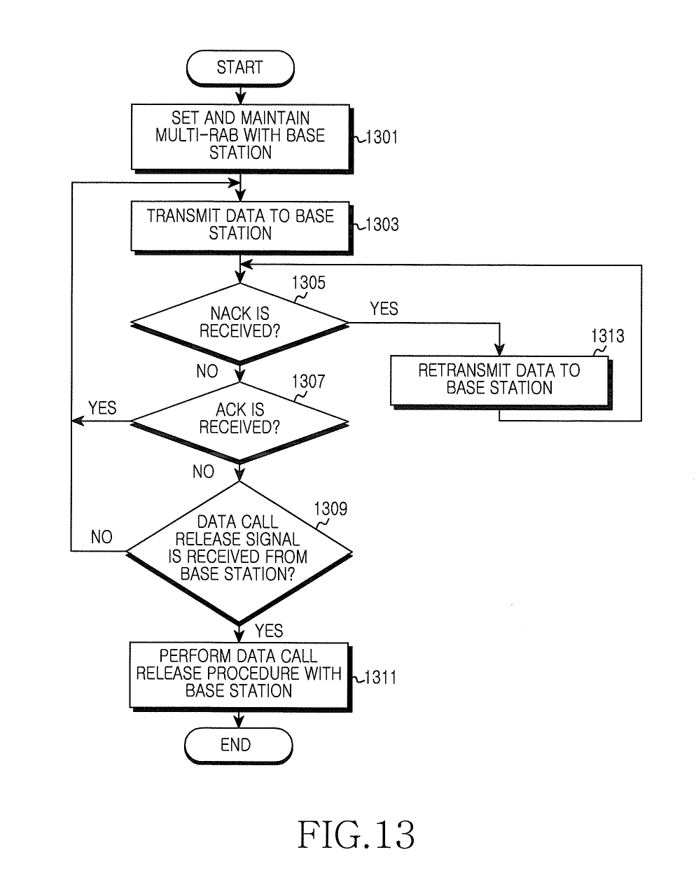

FIG. 13 illustrates a procedure for maintaining a voice call with a base station based on the number of data retransmissions by an electronic device according to embodiments of the present disclosure.

Referring to FIG. 13, the electronic device 900 sets a multi-RAB with the base station in block 1301. That is, the electronic device 900 connects a voice call and a data call with the base station 910.

After that, the electronic device 900 proceeds to block 1303 to transmit data to the base station 910. For example, the base station 910 transmits data to the electronic device 900 via the data call connected with the electronic device.

After transmitting data to the base station, the electronic device 900 proceeds to block 1305 to determine whether a NACK associated with the data transmitted in block 1303 has been received from the base station 910.

When receiving a NACK associated with the data transmitted in block 1303 from the base station, the electronic device 900 proceeds to block 1313 to retransmit data associated with the NACK to the base station 910.

In contrast, when not receiving a NACK associated with the data transmitted in block 1303 from the base station, the electronic device 900 proceeds to block 1307 to determine whether an ACK associated with the data transmitted in block 1303 has been received.

When receiving an ACK associated with the data transmitted in block 1303 from the base station, the electronic device 900 proceeds to block 1303 to transmit data to the base station 910.

In contrast, when not receiving an ACK associated with the data transmitted in block 1303 from the base station, the electronic device 900 proceeds to block 1309 to determine whether a release signal for the data call has been received from the base station 910. For example, the electronic device 900 determines whether a signal set to a PS domain has been received from the base station 910.

After transmitting data to the base station, when not receiving one of a NACK, an ACK, and a release signal for the data call for a reference time, the electronic device 900 determines that transmission of the data transmitted to the base station in block 1303 has failed. Accordingly, the electronic device 900 proceeds to block 1313 to retransmit, to the base station, data transmitted to the base station in block 1303.

In contrast, when receiving a data call release signal from the base station, the electronic device 900 proceeds to block 1311 to release the data call connection with the base station. At this point, the electronic device 900 maintains the voice call connection with the base station and continues to receive a voice service from the base station.

After that, the electronic device 900 ends the present algorithm.

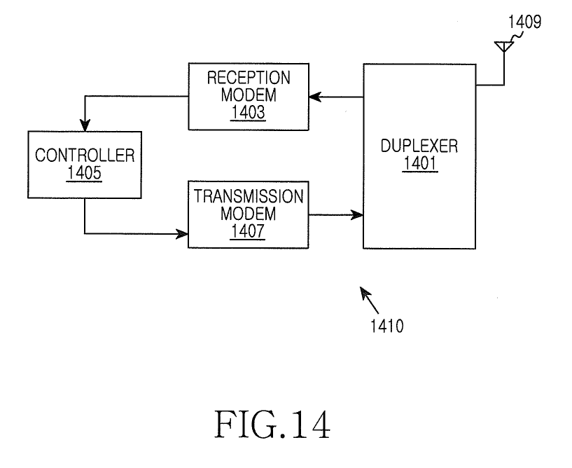

FIG. 14 illustrates a base station 1410 according to embodiments of the present disclosure.

As illustrated in FIG. 14, the base station 1410 includes a duplexer 1401, a reception modem 1403, a controller 1405, and a transmission modem 1407.

The duplexer 1401 connects the reception modem 1403 and the transmission modem 1407 with an antenna 1409 so that the reception modem 1403 and the transmission modem 1407 share one antenna to transmit/receive a signal. For example, during a reception section, the duplexer 1401 connects the reception modem 1403 with the antenna 1409. In contrast, during a transmission section, the duplexer 1401 connects the transmission modem 1407 with the antenna 1409.

The reception modem 1403 converts a Radio Frequency (RF) signal received via the antenna 1409 to a baseband signal and demodulates the baseband signal. For example, the reception modem 1403 includes an RF process block, a demodulation block, a channel decoding block, and a message process block. The RF process block converts an RF signal received via a channel for receiving a signal from a reception end via a reception antenna to a baseband signal under control of the controller 1405. The demodulation block includes a Fast Fourier Transform (FFT) operator for extracting data conveyed on each subcarrier from a signal provided from the RF process block. The channel decoding block includes a demodulator, a deinterleaver, and a channel encoder, and demodulates and decodes a signal provided from the demodulation block. The message process block detects an ACK/NACK message provided from the reception end and provides the same to the controller 1405.

The controller 1405 controls an overall operation of the base station 1410. Particularly, the controller 1405 controls to set and maintain a multi-radio access link with an electronic device 1400. When an error of a data call with the electronic device occurs, the controller 1405 releases the data call in order to prevent connections of the data call and a voice call from being released due to the error of the data call with the electronic device. For example, when the electronic device 1400 requests release of the data call connection, the controller 1405 instructs the electronic device to release the data call connection as illustrated in FIG. 3, 5, or 7. For another example, when determining an error of the data call with the electronic device, the controller 1405 controls or instructs the electronic device to release the data call connection as illustrated in FIG. 10 or 12.

The transmission modem 1407 encodes data and a control signal to transmit to a reception end and converts them to RF signals to transmit the same to the reception end via a transmission antenna. For example, the transmission modem 1407 includes a message generate block, a channel encoding block, a modulation block, and an RF process block. The message generate block generates channel information for transmitting data or channel information for retransmitting data. For example, in case of releasing the connection of the data call with the electronic device, the message generate block generates a data call release signal that has set a domain to a PS domain under control of the controller 1405. The channel encoding block includes a modulator, an interleaver, and a channel encoder to encode and modulate a transmission signal. The modulation block includes an IFFT operator for mapping a signal provided from the channel encoding block to each subcarrier. The RF process block converts a baseband signal provided from the modulation block to an RF signal and transmits the same to the reception end via a transmission antenna.

Though not shown, the base station can further include an error determination unit for determining whether an error of data provided from the electronic device occurs.

In certain embodiments, the reception modem 1403 and the transmission modem 1407 of the base station 1410 share one antenna 1409 to transmit/receive a signal. In certain embodiments, the reception modem 1403 and the transmission modem 1407 of the base station transmit/receive a signal via different antennas, respectively.

In certain embodiments, the base station 1410 connects the voice call and the data call with the electronic device together using one reception modem 1403 and one transmission modem 1407. In certain embodiments, the base station 1410 can include a reception modem and a transmission modem for a voice call, and include a reception modem and a transmission modem for a data call.

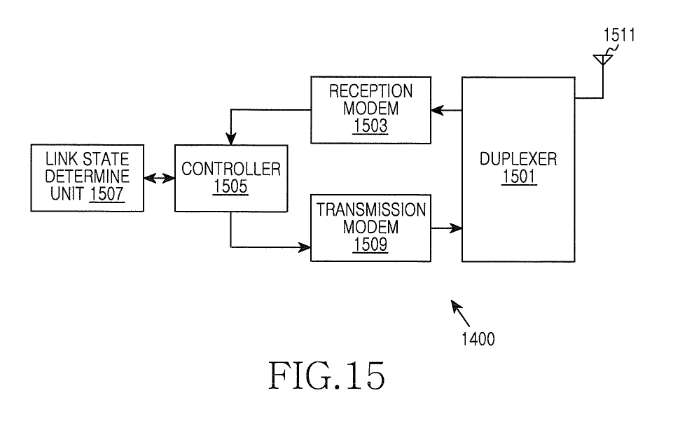

FIG. 15 is a block diagram illustrating an electronic device 1400 according to embodiments of the present disclosure.

As illustrated in FIG. 15, the electronic device 1400 includes a duplexer 1501, a reception modem 1503, a controller 1505, a link state determine unit 1507, and a transmission modem 1509.

The duplexer 1501 connects the reception modem 1503 and the transmission modem 1509 with an antenna 1511 so that the reception modem 1503 and the transmission modem 1509 can share one antenna 1511 to transmit/receive a signal. For example, during, a reception section, the duplexer 1501 connects the reception modem 1503 with the antenna 1511. In contrast, during a transmission section, the duplexer 1501 connects the transmission modem 1509 with the antenna 1511.

The reception modem 1501 converts an RF signal received via the antenna 1511 to a baseband signal, and demodulates the same. For example, the reception modem 1501 includes an RF process block, a demodulation block, a channel decoding block, and a message process block. The RF process block converts an RF signal received via a channel for receiving a signal from a transmission end via a reception antenna to a baseband signal under control of the controller 1505. The demodulation block includes an FFT operator for extracting data conveyed on each subcarrier from a signal provided from the RF process block. The channel decoding block includes a demodulator, a deinterleaver, and a channel decoder to demodulate and decode a signal provided from the demodulation block. The message process block detects channel information for data transmission and channel information for data retransmission provided from the transmission end and provides the same to the controller 1503.

The controller 1503 controls an overall operation of the electronic device 1400. Particularly, the controller 1503 controls to set and maintain a multi-radio access link with the base station. In the case where the link state determine unit 1507 determines that an error of a data call with the base station occurs, the controller 1505 releases the data call in order to prevent connections of the data call and a voice call from being released due to the error of the data call with the base station. For example, in the case where the link state determine unit 1507 determines that an error of a data call with the base station occurs, the controller 1505 requests the base station 1410 to release connection of the data call as illustrated in FIG. 2, 4, 6, or 8. For another example, in the case where the base station 1410 instructs to release of the data call, the controller 1505 releases the data call with the base station as illustrated in FIG. 11 or 13.

The link state determination unit 1507 determines the state of a radio link with the base station.

The transmission modem 1509 encodes data and a control signal to transmit to the base station 1410 and converts them to RF signals, and transmits the same to a transmission end via a transmission antenna. For example, the transmission modem 1509 includes a message generate block, a channel encoding block, a modulation block, and an RF process block. The message generate block generates a control signal to transmit to the base station. For example, the message generate block generates a SCRI in order to request release of a data call connection under control of the controller 1505. For another example, the message generate block generates an ACK/NACK associated with the data provided from the base station 1410. The channel encoding block includes a modulator, an interleaves, and a channel encoder to encode and modulate a transmission signal. The modulation block includes an IFFT operator for mapping a signal provided from the channel encoding block to each subcarrier. The RF process block converts a baseband signal provided from the modulation block to an RF signal and transmits the same to the base station via the antenna 1511.

Though not shown, the electronic device 1400 can further include an error determination unit for determining whether an error of data provided from the base station 1410 occurs.

In certain embodiments, the reception modem 1503 and the transmission modem 1509 of the electronic device share one antenna 1511 to transmit/receive a signal. In another embodiment, the reception modem 1503 and the transmission modem 1509 of the electronic device transmit/receive a signal via different antennas, respectively.

In certain embodiments, the electronic device 1400 connects a voice call and a data call with the base station 1410 together using one reception modem 1503 and one transmission modem 1509. In certain embodiments, the electronic device 1400 includes a reception modem and a transmission modem for a voice call, and includes a reception modem and a transmission modem for a data call.

As described above, when an error of a data call occurs in a communication system providing a multi-RAB service, the embodiments of present disclosure can release the data call while maintaining the voice call connection, thereby maintaining the voice call even when the error of the data call occurs to improve communication quality.

Although the invention has been shown and described with reference to certain embodiments thereof, it will be understood by those skilled in the art that various changes in form and details may be made therein without departing from the spirit and scope of the appended claims and their equivalents. Therefore, the scope of the present disclosure is not be limited to the above-described embodiments but should be determined by not only the appended claims but also the equivalents thereof.

What is claimed is:

1. A method for maintaining a voice call in an electronic device providing a multi-Radio Access Bearer (RAB), the method comprising:
connecting a data call and a voice call with a wireless network; and
when an error of the data call is detected, releasing the connection of the data call with the wireless network to maintain the voice call with the wireless network.

2. The method of claim 1, further comprising, after connecting the data call and the voice call with the wireless network:
when receiving a data retransmission request signal from the wireless network, determining whether the error of the data call occurs based on the number of retransmissions of data,
wherein when the error of the data call is detected, releasing the connection of the data call with the wireless network.

3. The method of claim 1, further comprising, after connecting the data call and the voice call with the wireless network:
receiving data from the wireless network; and
when the error of the data call occurs, determining whether the error of the data call occurs based on the number of retransmission requests for the data,
wherein when the error of the data call is detected, releasing the connection of the data call with the wireless network is performed.

4. The method of claim 1, further comprising, after connecting the data call and the voice call with the wireless network:
determining whether the error of the data call occurs based on a channel state with the wireless network,
wherein when the error of the data call is detected, releasing the connection of the data call with the wireless network.

5. The method of claim 1, wherein releasing the connection of the data call comprises:
when detecting the error of the data call, requesting the wireless network to release the data call; and
when receiving a response signal to a release request for the data call from the wireless network, releasing the connection of the data call with the wireless network.

6. The method of claim 5, wherein requesting the wireless network to release the data call comprises:
transmitting Signaling Connection Release Indication (SCRI) to the wireless network.

7. The method of claim 1, further comprising:
when releasing the data call, maintaining a Packet Data Protocol (PDP) context.

8. A method for maintaining a voice call in a base station providing a multi-Radio Access Bearer (RAB), the method comprising:
connecting a data call and a voice call with an electronic device; and
when an error of the data call is detected, releasing the connection of the data call with the electronic device to maintain the voice call with the electronic device.

9. The method of claim 8, further comprising, after connecting the data call and the voice call with the electronic device:
when receiving a data retransmission request signal from the electronic device, determining whether the error of the data call occurs based on the number of retransmissions of data,
wherein when the error of the data call is detected, releasing the connection of the data call with the electronic device.

10. The method of claim 8, further comprising, after connecting the data call and the voice call with the electronic device:
receiving data from the electronic device; and
when the error of the data call occurs, determining whether the error of the data call occurs based on the number of retransmission requests for the data,
wherein when the error of the data call is detected, releasing the connection of the data call with the electronic device.

11. The method of claim 8, wherein releasing the connection of the data call comprises:
when detecting the error of the data call, instructing the electronic device to release the data call; and
releasing the connection of the data call with the electronic device.

12. An apparatus of an electronic device providing a multi-Radio Access Bearer (RAB), the apparatus comprising:
a receiver configured to receive a signal;
a transmitter configured to transmit a signal; and
a controller configured to connect a data call and a voice call with a wireless network using the receiver and the transmitter, and when an error of the data call is detected, release the connection of the data call with the wireless network to maintain the voice call with the wireless network.

13. The apparatus of claim 12, wherein after connecting the data call and the voice call with the wireless network, when receiving a data retransmission request signal from the wireless network, the controller is configured to determine whether the error of the data call occurs based on the number of retransmissions of data.

14. The apparatus of claim 12, wherein after connecting the data call and the voice call with the wireless network, when the error of the data call received from the wireless network occurs, the controller is configured to determine whether the error of the data call occurs based on the number of retransmission requests for the data.

15. The apparatus of claim 12, wherein after connecting the data call and the voice call with the wireless network, the controller is configured to determine whether the error of the data call occurs based on a channel state with the wireless network.

16. The apparatus of claim 12, wherein when detecting the error of the data call, the controller requests the wireless network to release the data call via the transmitter, and when receiving a response signal to a release request of the data call from the wireless network, the controller is configured to release the connection of the data call with the wireless network.

17. The apparatus of claim 16, wherein the transmitter is configured to transmit Signaling Connection Release Indication (SCRI) to the wireless network.

18. The apparatus of claim 12, wherein when releasing the data call, the controller is configured to maintain Packet Data Protocol (PDP) context.

19. An apparatus for a base station providing a multi-Radio Access Bearer (RAB), the apparatus comprising:
a transmitter configured to transmit a signal;
a receiver configured to receive a signal; and
a controller configured to connect a data call and a voice call with an electronic device using the transmitter and the receiver, and when an error of the data call is detected, release the connection of the data call with the electronic device to maintain the voice call with the electronic device.

20. The apparatus of claim 19, wherein after connecting the data call and the voice call with the electronic device, when receiving a data retransmission request signal from the electronic device, the controller is configured to determine whether the error of the data call occurs with consideration of the number of retransmissions of data.

21. The apparatus of claim 19, wherein after connecting the data call and the voice call with the electronic device, when an error of data received from the electronic device occurs, the controller is configured to determine whether the error of the data call occurs based on the number of retransmission requests of the data.

22. The apparatus of claim 19, wherein when detecting the error of the data call, the controller is configured to instruct the electronic device to release the data call to release the connection of the data call with the electronic device.
